(19) United States
(12) Patent Application Publication
(10) Pub. No.: US 2020/0324699 A1
(43) Pub. Date: Oct. 15, 2020

(54) Early warning system of failures of safety and operating lights to all drivers of all types of vehicles.

(71) Applicant: ADARSH KOHLI, Centennial, CO (US)

(72) Inventor: ADARSH KOHLI, Centennial, CO (US)

(21) Appl. No.: 16/501,421

(22) Filed: Apr. 10, 2019

(51) Int. Cl. B60Q 11/00; G07C 5/08; G07C 5/06

(52) U.S. Cl. CPC B60Q 11/005; G07C 5/06; G07C 5/0825

(57) ABSTRACT

The present invention is a novel and new method of detecting the failure of safety signaling and operational lights on the vehicle and giving a warning to the Driver of the Vehicle being driven at the start or during the time on the road.

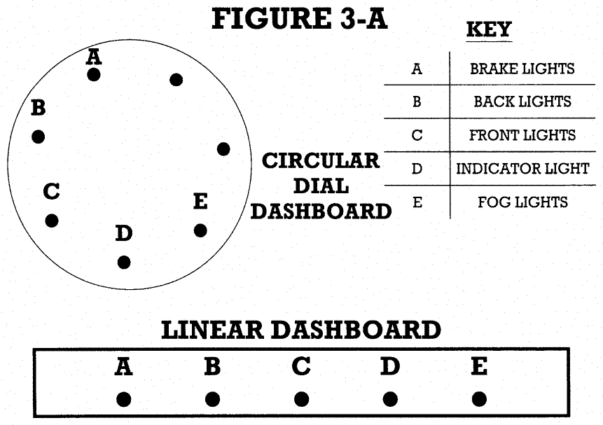

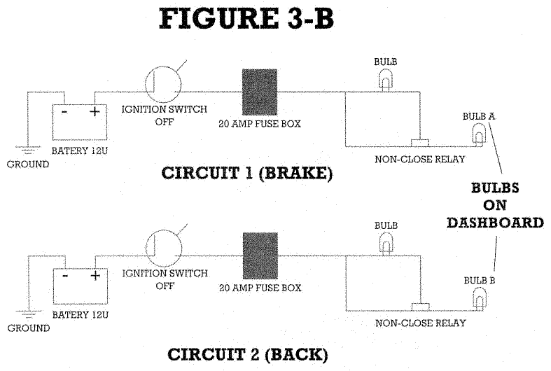

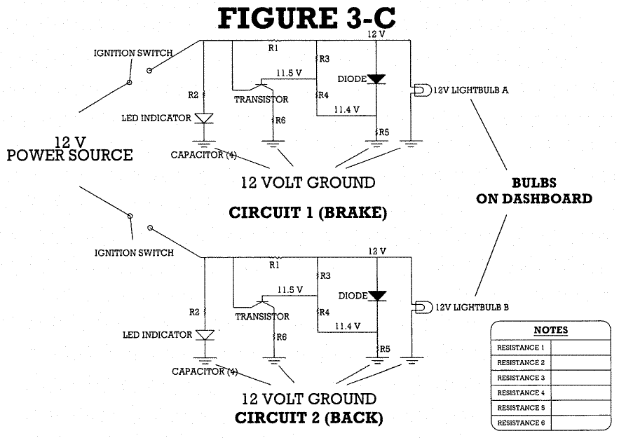

This is achieved by adding additional wiring to each of the signaling or operational lights and connecting to the Visible Dashboard in front of the vehicle. This will reduce the risks of accidents due to the failure of a particular external light of the vehicle being driven. This will be achieved at a small cost by adding relay, transistors or chips to the additional circuits of the forewarning system.

### BACKGROUND

This is a new innovation to warn the drivers of all the categories of vehicles before Starting or during driving of the failure of safety and other operating lights or lighting system (s) of the vehicle.

The proposed patent is as follows

All lights of a vehicle like back lights, break lights, flash hazard lights, indicator lights, front lights, fog lights will be individually connected with additional proper electric circuit to a screen on the Dashboard visible to the driver in front of his/her seat

The screen will have a bulb corresponding to each proposed circuit representing and marked for each type of external light of the vehicle. When the driver starts the vehicle and one or more lights on the dashboard light up corresponding to the external lights, will give instant warning to the driver that a particular external light of the vehicle is out or has failed or is not working. The electric circuits can be made also be connected in the reverse order showing all lights of the additional circuit light up on the dashboard and the only failed light (s) not lighting up on the Dashboard. The result will be the same as to forewarn the driver and give him the opportunity to fix it and thus reduce risks (his own and others) on the road. Even during the driving if the lights come on or go off depending upon the system installed he will be forewarned.

Benefits

The brake lights have a function to indicate to the drivers of vehicles coming in the back that front vehicle is stopping or trying to stop so that they can also slow down or apply brake. If the brake lights have failed it may not give a signal to the driver coming in another vehicle behind this driver. This may result in rear ending specially during night time of the front vehicle. The proposed forewarning system can thus reduce the risk of an accident.

Similarly, failure of any other light of the vehicle designed to have a safer driving will come to the notice of the driver before the vehicle is on road or has failed while driving.

The system of early warning will improve safety of not only the vehicle with failed one or more lights it will also improve the overall safety of other vehicles driving on the road at the same time.

### EXPLANATION OF DRAWINGS

There are three drawings

Drawing 3 A

It explains the display method to the driver of the vehicle. The Display will be in front of the driver either in a Linear Circular or triangular in shape with multiple or single displays on the Dashboard. The numbers A corresponds to Brake Lights

B to Back Lights and so on all the additional circuit(s) installed will be displayed on the dashboard

C D E and more numbers represent the correspond to the external lights of the vehicle.

Drawing 3b

This drawing shows two additional circuits for illustration only namely 1 and 2. The basic circuits use the same connection and are a clone for the other circuits and proposed to be added. This has been done to improve the readability and understanding the concept.

The circuit shows a battery with negative to the earth and there is a non closing relay in the electric wiring connected thru the light bulb the failure of which is to be detected. When the light bulb has failed the bulb A on dashboard will get current flow thru the relay and light up. The lighted bulb will indicate to the driver the failure of that particular system of Brake or Back light as the case may be. In the event the Brake light is working Ok the current will not flow thru the relay and Bulb A will not light up thus letting the Driver know that there is nothing wrong with Brake light.

Drawing 3 c

This drawing shows that the above result can also be achieved by using suitable transistors which are more inexpensive than relays. When an external bulb is not passing the current thru it the current takes alternate route thru transistors and completes the circuit for Bulb A B C or any other on the dashboard and lights up. Thus giving a warning to the driver that a particular safety, signaling or operating light system is not working.

REPLY REPLY ALL FORWARD

1. This is a unique system of forewarning the drivers of a vehicle of the possible failure of the signaling and operating lights by adding additional circuits to the existing circuits to the existing wiring of all the external lights and displaying the results on the Dashboard while starting or later during moving of the Vehicle.

2. This system detects a particular failed light or system of signaling not working at the start of while on the road.

3. The additional circuits can use any method of wiring like relay system, transistors, chips or circuit breakers of all types.
